(19) United States
(12) Patent Application Publication
(10) Pub. No.: US 2025/0000058 A1
(43) Pub. Date: Jan. 2, 2025

(54) AVERSIVE ELECTROSHOCK APPLICATION FOR BEHAVIOR MODIFICATION IN INSECTS

(71) Applicant: JuvaTech, LLC, Toledo, OH (US)

(72) Inventor: Sebastian Huber, Toledo, OH (US)

(73) Assignee: JuvaTech, LLC, Toledo, OH (US)

(21) Appl. No.: 18/710,125

(22) PCT Filed: Nov. 15, 2022
(86) PCT No.: PCT/US2022/049915

§ 371 Date: May 14, 2024

Related U.S. Application Data
(60) Provisional application No. 63/279,846, filed on Nov. 16, 2021.

(51) Int. Cl. A01K 15/02

(52) U.S. Cl. CPC A01K 15/029

(57) ABSTRACT

An aversive electroshock device useful for the evaluation of effects on pain tolerance or pain sensation by pharmaceutical compounds or other substances or conditions, and methods for applying aversive stimuli to organisms and measuring pain perceived by organisms, are described. The aversive electroshock device can be used to measure the organism's ability to learn.

### RELATED APPLICATIONS

This application claims priority to U.S. Provisional Application No. 63/279,846 filed under 35 U.S.C. § 111(b) on Nov. 16, 2021, the disclosure of which is incorporated herein by reference in its entirety for all purposes.

### STATEMENT REGARDING FEDERALLY SPONSORED RESEARCH

This invention was made with no government support. The government has no rights in this invention.

### BACKGROUND

There are challenges when attempting to test pharmaceuticals and other substances, in particular when seeking to discover new pain killers. For example, there are ethical issues regarding the testing on certain organisms. There is also the problem of finding a type of organism that reacts to pain in the same way that humans do. Testing can be done on any type of organism; however, it may not be beneficial to the study of pharmaceuticals. Also, the current methods of testing pharmaceuticals are limited. Thus, there is a need in the art for new and improved methods and devices to facilitate testing pharmaceutical compounds on organisms.

### SUMMARY

Provided herein is an aversive electroshock device comprising a board with a first surface and a second surface, the first surface comprising a first grid having a first positive electrical contact and a first negative electrical contact, and a second grid having a second positive electrical contact and a second negative electrical contact; a first connection point on the first surface in electrical communication with the first positive contact and the first negative contact; and a second connection point on the first surface in electrical communication with the second positive contact and the second negative contact.

In certain embodiments, the device further comprises at least one wall that is at least partially around a perimeter of the board. In particular embodiments, the device further comprises a ceiling at least partially enclosing the first surface of the board.

In certain embodiments, an external power supply is configured to apply an electric current to the first connection point or the second connection point. In certain embodiments, an internal power supply is configured to apply an electric current to the first connection point or the second connection point.

In certain embodiments, the device further comprises a computer, a microcontroller, or a microprocessor configured to adjust an intensity of an electric current delivered to the first connection point or the second connection point.

In certain embodiments, the device further comprises a camera configured to observe the board.

In certain embodiments, the first connection point or the second connection point protrudes through the board.

In certain embodiments, the first grid and the second grid each comprises metallic channels. In particular embodiments, the metallic channels comprise alternating traces.

In certain embodiments, the board comprises a glass-reinforced epoxy resin.

In certain embodiments, the device comprises a space on the board between the first grid and the second grid. In certain embodiments, there is no space on the board between the first grid and the second grid.

In certain embodiments, the board includes two areas that are rectangles. In particular embodiments, the rectangles are of equal size.

Further provided is a method for applying an electric shock to an organism, the method comprising electrifying the first grid of the aversive electroshock device described herein at a known intensity while not electrifying the second grid; allowing an organism onto the first grid, wherein the organism contacts the first positive contact and the first negative contact to complete a circuit and receive an electric shock; and observing a degree to which the organism avoids the first grid.

In certain embodiments, the known intensity is a specific voltage.

In certain embodiments, the degree is a control degree of avoidance, and the method further comprises administering a test pharmaceutical compound to the organism after observing the control degree of avoidance; and observing a second degree to which the organism avoids the first grid, wherein a difference between the control degree of avoidance and the second degree indicates an effect by the test pharmaceutical compound on how the organism perceives pain.

In certain embodiments, the organism is a fly. In certain embodiments, the organism is a fruit fly.

In certain embodiments, the electrical shock comprises a constant application of a specific voltage. In certain embodiments, the electrical shock comprises a defined progression of different shock intensities. In certain embodiments, the electrical shock comprises an alternating current in one of a range of frequencies and intensities.

In certain embodiments, the method further comprises tracking movement of the organism with a tracking software.

In certain embodiments, the method further comprises increasing an intensity of the electric shock delivered to the organism incrementally over time.

In certain embodiments, the method is used for testing an effect on the degree by a pharmaceutical compound.

In certain embodiments, the method further comprises determining a minimum voltage needed to bring about a degree of avoidance as a measure for an intensity threshold which is perceived as painful or noxious.

In certain embodiments, the degree represents a measure of pain that the organism receives.

In certain embodiments, the method further comprises administering a test compound to the organism prior to allowing the organism onto the first grid.

In certain embodiments, the method further comprises applying a light stimulus to the organism.

In certain embodiments, the method further comprises applying a sound stimulus to the organism. In certain embodiments, the method further comprises applying a chemical stimulus to the organism. In certain embodiments, the method further comprises applying an odorant stimulus to the organism. In certain embodiments, the method comprises determining a minimum voltage needed to bring about a degree of avoidance as a measure for an intensity threshold which is perceived as painful or noxious.

Further provided is a method for applying an electric shock to an organism, the method comprising allowing an organism onto the first grid of the aversive electroshock device described herein; electrifying the first grid at a known intensity while not electrifying the second grid, wherein the electrifying causes an electric current to flow through the organism upon the organism contacting the first positive contact and the first negative contact; and observing a degree to which the organism avoids the first grid.

In certain embodiments, the known intensity is a specific voltage.

In certain embodiments, the degree is a control degree of avoidance, and the method further comprises administering a test pharmaceutical compound to the organism after observing the control degree of avoidance; and observing a second degree to which the organism avoids the first grid, wherein a difference between the control degree of avoidance and the second degree indicates an effect by the test pharmaceutical compound on how the organism perceives pain.

In certain embodiments, the organism is a fly. In certain embodiments, the organism is a fruit fly.

In certain embodiments, the electrical shock comprises a constant application of a specific voltage. In certain embodiments, the electrical shock comprises a defined progression of different shock intensities. In certain embodiments, the electrical shock comprises an alternating current in one of a range of frequencies and intensities.

In certain embodiments, the method further comprises tracking movement of the organism with a tracking software.

In certain embodiments, the further comprises increasing an intensity of the electric shock delivered to the organism incrementally over time.

In certain embodiments, the method is used for testing an effect on the degree by a pharmaceutical compound.

In certain embodiments, the method further comprises determining a minimum voltage needed to bring about a degree of avoidance as a measure for an intensity threshold which is perceived as painful or noxious.

In certain embodiments, the degree represents a measure of pain that the organism receives.

In certain embodiments, the method further comprises administering a test compound to the organism prior to allowing the organism onto the first grid.

In certain embodiments, the method further comprises applying a light stimulus to the organism.

In certain embodiments, the method further comprises applying a stimulus to the organism. In certain embodiments, the method further comprises applying a chemical stimulus to the organism. In certain embodiments, the method further comprises applying an odorant stimulus to the organism. In certain embodiments, the method comprises determining a minimum voltage needed to bring about a degree of avoidance as a measure for an intensity threshold which is perceived as painful or noxious.

Further provided is a method for startling an organism with a presentation of an electric shock, the method comprising surprising or frightening an organism with an electric shock so as to disrupt a behavior by the organism with an aversive condition to discourage the organism from performing an action, wherein the electric shock is applied to the organism while the organism is disposed on a positive contact and a negative contact on a board. In certain embodiments, the electric shock is paired with an appetitive condition to judge processes of decision-making and to examine relative valuation of reward and punishment.

Further provided is a method of measuring the pain threshold of an organism, the method comprising placing an organism into an area comprising a first region and a second region, wherein the first region is configured to deliver an aversive stimulus to the organism while the second region is safe from the aversive stimulus; incrementally increasing an intensity of the aversive stimulus over time; and measuring a strength of an avoidance reaction by the organism as a function of the intensity, wherein a minimum intensity needed to bring about avoidance of the first region represents a measure for an intensity threshold at which the aversive stimulus is perceived as painful or noxious, and a degree of avoidance at a higher intensity represents a measure of how painful the aversive stimulus is perceived by the organism.

In certain embodiments, the first region is electrified, and a state of electrification of the first region is coordinated with a state of a signal. In particular embodiments, a signaling cue acts as a warning signal that precedes application of an electric shock to warn the organism of an imminent electric shock or to reflect a current state of electrical activation. In particular embodiments, a paired cue is used to signal the potential for activating electrical shock when additional conditions are met. In particular embodiments, the paired cue comprises a light, a sound, or a chemical.

In certain embodiments, the aversive stimulus comprises a constant or pulsed electric shock of a magnitude sufficient to cause avoidance. In certain embodiments, the aversive stimulus comprises multiple electric shocks in a series.

Further provided is a method of evaluating the degree of learning through classical cue conditioning, the method comprising observing an organism; activating a neutral signal cue followed by delivering an aversive condition; and identifying conditioned changes in preference for a paired signal cue; wherein the aversive condition is an electric shock delivered through a grid on a board. In certain embodiments, the organism is a fly. In certain embodiments, the organism is a fruit fly.

Further provided is a method for applying an electric shock to an organism, the method comprising applying an electrical current to a connection point that is electrically connected to a grid having a positive contact and a negative contact thereon; and placing an organism on the grid so as to touch the positive contact and the negative contact and thereby complete a circuit through the organism and deliver an electric shock to the organism. In certain embodiments, the organism is an insect. In certain embodiments, the organism is a vertebrate organism. In certain embodiments, the organism is an invertebrate organism. In certain embodiments, the organism is a fly. In certain embodiments, the organism is a fruit fly.

In certain embodiments, the method comprises applying a defined progression of different shock intensities to the organism. In certain embodiments, the method comprises increasing an intensity of the electric shock delivered to the organism incrementally over time. In certain embodiments, the electric shock comprises a constant application of a specific voltage. In certain embodiments, the electric shock comprises an alternating current in one of a range of frequencies and intensities. In certain embodiments, the electric shock comprises a sequence of pulses of defined frequency, duration, and intensity of direct current. In certain embodiments, the electric shock comprises alternating current in one of a range of frequencies and intensities.

Further provided is a method for testing pharmaceutical compounds comprising administering a test compound to an organism prior to applying the electric current to deliver the electric shock to the organism with an aversive electroshock device as described herein. In certain embodiments, the method further comprises administering a test compound to the organism after applying the electric current to deliver the electric shock to the organism, and then applying a second electric current to deliver a second electric shock to the organism, and observing a difference in the pain threshold of the organism from the electric shock and the second electric shock.

In certain embodiments of a device or method provided herein, the organism is on an electrifiable platform within an at least partly enclosed area having sidewalls or a ceiling.

In certain embodiments of a method provided herein, a voltage for electrifying a grid is provided though an external power connector.

In certain embodiments of a method provided herein, one or more independently controlled shock zones are utilized. In certain embodiments, an area is covered by a tessellated mosaic of independently controlled shock regions.

In certain embodiments of a method provided herein, an application of shock is controlled by a microprocessor or a computer.

In certain embodiments of a device or method provided herein, a device further comprises a video camera configured to observe within the area. In particular embodiments, the device further comprises a video camera configured to observe organisms in a first area or a second area. In particular embodiments, a system is provided that comprises a device as described herein and further comprises tracking software configured to track movement of the organisms in either of the first area or the second area.

In certain embodiments of a method provided herein, an activation of an electrified grid is paired with cues that signal and enhance the aversive nature of the electric shock. In certain embodiments, changes in intensity of the electrified grid are paired with cues that signal and enhance the aversive nature of the electric shock.

Further provided is a method for startling an organism with a presentation of an electric shock. In certain embodiments the application of electric shock can surprise or frighten an organism. In certain embodiments, the application of electric shock can disrupt an organism's behavior by using an aversive condition to discourage an organism from performing a particular action. In certain embodiments, the aversive application of electric shock is paired with an appetitive condition to judge processes of decision-making and to examine relative valuation of reward and punishment.

Further provided is a method of measuring the pain threshold of an organism, the method comprising placing an organism into an area in which one area is set to deliver an aversive stimulus while another region is safe from the aversive stimulus; incrementally increasing the intensity of the aversive stimulus over time; and measuring the strength of an avoidance reaction as a function of shock intensity. The minimum voltage needed to bring about avoidance of the area offers a measure for the intensity threshold at which the stimulus condition is perceived as painful or noxious. The degree of avoidance at higher voltages represents a measure of how painful the shock is perceived by the organisms.

In certain embodiments, the state of electrification of a zone is coordinated with the state of a signal. In certain embodiments, the method controls a light stimulus. In certain embodiments, the method controls a sound stimulus. In certain embodiments, the method coordinates the release of a chemical or odorant stimulus.

In certain embodiments, a signaling cue acts as a warning signal. In certain embodiments, the warning signal precedes the activation of shock, warning a resident individual of imminent changes to the area's electrical state. In certain embodiments, the signaling cue is reflecting the current state of electrical activation, giving information as to whether it is safe to enter the area. In certain embodiments, the paired cue is used to signal the potential for activating electrical shock when additional conditions are met.

Further provided is a method of evaluating the degree of learning through classical cue conditioning, the method comprising observing an organism; activating a neutral signal cue followed by the delivery of an aversive condition; and identifying conditioned changes in preference for the paired cue. The test subject learns to associate the paired cue with the painful consequence of a shock. In certain embodiments, the paired cue comprises a light, a sound, or a chemical. In certain embodiments, the warning cue is an initial activation of the electrical grid.

In certain embodiments, the aversive condition comprises administering a constant or pulsed electric shock of a magnitude sufficient to cause avoidance. In certain embodiments, the painful condition comprises administering single or multiple electric shocks in a series. In certain embodiments, the painful condition comprises administering constant or pulsed electric shock of a magnitude sufficient to cause avoidance. In certain embodiments, the painful condition comprises administering single or multiple electric shocks.

Further provided is a system which pairs an aversive electric shock condition with an appetitive condition, such as food or agreeable environmental conditions. In certain embodiments, the system controls the balance of reward and punishment with a graded manipulation of both aversive and appetitive conditions.

Further provided is a system for evaluating the degree of spatial learning of the location of an electrified region based on the arrangement of surrounding, predictive cues. In certain embodiments, the paired cue comprises exposure to light, a sound, or an odor.

Further provided is a method for testing spatial memory through sensory cue conditioning, the method comprising placing an organism into an area comprising a plurality of grids, wherein a first grid of the plurality of grids is not supplied with electricity while a remainder of the plurality of grids is supplied with electricity so as to deliver an electric shock to the organism when the organism is positioned on any of the remainder of the plurality of grids; observing the organism over a period of time; and identifying changes in a preference of the organism for the first grid. In certain embodiments, the method comprises measuring a relative amount of time spent by the organism on the first grid compared to any of the remainder of the plurality of grids.

In certain embodiments, the method further comprises cues that are presented indicating a safe area. In particular embodiments, the cues are LEDs in the wall or around the grid. In particular embodiments, the cues are panels of color.

In certain embodiments, the method is used for testing for a neurodegenerative disease, such as dementia.

In certain embodiments, the organism is a fly. In certain embodiments, the organism is a fruit fly.

### BRIEF DESCRIPTION OF THE DRAWINGS

The patent or application file may contain one or more drawings executed in color and/or one or more photographs. Copies of this patent or patent application publication with color drawing(s) and/or photograph(s) will be provided by the U.S. Patent and Trademark Office upon request and payment of the necessary fees.

FIG. 1: Illustration of a non-limiting example embodiment of an aversive electroshock device.

FIGS. 2A-2B: Illustrations of another non-limiting example embodiment of an aversive electroshock device having a first grid and a second grid. In FIG. 2A, there is a space between the first grid and the second grid. In FIG. 2B, there is no space between the first grid and the second grid.

FIG. 3: Illustration of another non-limiting example embodiment of an aversive electroshock device having a grid on a second surface.

FIG. 4: Illustration of another non-limiting example embodiment of an aversive electroshock device having a connection point on a second surface.

FIG. 5: Illustration of another non-limiting example embodiment of an aversive electroshock device with walls partially around the perimeter.

FIG. 6: Illustration of another non-limiting example embodiment of an aversive electroshock device having walls partially around a perimeter and a ceiling partially enclosing a first surface.

FIG. 7: Illustration of another non-limiting example embodiment of an aversive electroshock device having a connection point protruding through a board.

FIG. 8: Illustration of another non-limiting example embodiment of an aversive electroshock device attached to a power supply.

FIG. 9: Illustration of another non-limiting example embodiment of an aversive electroshock device attached to a computer or a microcontroller.

FIG. 10: Illustration of another non-limiting example embodiment of an aversive electroshock device comprising a camera configured to observe the board.

FIG. 11: Illustration of another non-limiting example embodiment of an aversive electroshock device comprising a grid, resisters, diodes, and connectors.

FIG. 12: Graph showing a series of increasing voltages applied to one side of an arena.

FIG. 13: Graph of an observed avoidance behavior of 30 files tested individually.

### DETAILED DESCRIPTION

Throughout this disclosure, various publications, patents, and published patent specifications are referenced by an identifying citation. The disclosures of these publications, patents, and published patent specifications are hereby incorporated by reference into the present disclosure in their entirety to more fully describe the state of the art to which this invention pertains.

Provided herein is an aversive electroshock device configured to apply an aversive stimulus to an organism. The aversive electroshock device can be configured to be used for a multitude of purposes including, but not limited to, testing pharmaceutical compounds for the effectiveness at reducing pain or otherwise affecting a pain tolerance of an organism. Advantageously, rather than testing the pharmaceutical compounds on people or other mammals, the aversive electroshock device allows for testing pharmaceutical compounds on an organism with fewer ethical considerations, such as a fruit fly. Also provided is a method for measuring the pain experienced by the organism to yield results about the effectiveness of pharmaceutical compounds at inhibiting or reducing pain. In accordance with the present disclosure, an electric shock of sufficient magnitude causes an aversive response in organisms. Provided is a method for electrifying an area by placing narrowly spaced, thin conductive traces of opposing contacts on a board, and subjecting an individual organism to an electric shock when the opposing traces are contacted simultaneously. The board contains a non-electrified grid for the organism to move to, indicating that a pain threshold has been reached.

The ability to administer transient electrical shocks of defined shape and intensity allows for the identification of the minimum level of electrical stimulation required to cause an aversive reaction. Without wishing to be bound by theory, it is believed that the minimum stimulus intensity needed for causing aversive reactions reflects the threshold at which an organism perceives a stimulus as aversive.

The methods described herein are advantageous compared to known methods of administering aversive conditions to freely behaving organisms such as fruit flies. In contrast, known methods for inflicting painful or aversive stimuli involve the use of heated surfaces, focused beams of energy, or noxious odors, all of which suffer from slow on and off kinetics, a limited ability to control the stimulus intensity, or a use restricted to very limited spatial locations. Current methods for applying electric shocks require a very specific configuration of the organism relative to the stimulating electrodes. However, as described herein, a fine grid of exposed traces connected to alternating electrical contacts can be affixed to the floor, wall, or ceiling of the testing apparatus, and can be used to deliver an electric shock of a variable and desired intensity.

Flies, as a non-limiting example of an organism to be analyzed, can discriminate blue light from green light. This ability may be exploited by pairing an electrified surface with a color cue. For example, the color blue may be paired with subsequent activation of electric shock. The extent to which a fly's preference for that color changes as a result of the pairing indicates the dynamics and strength of classical conditioning. It is understood that, although flies are described for ease of explanation, the present disclosure is not limited to use with flies.

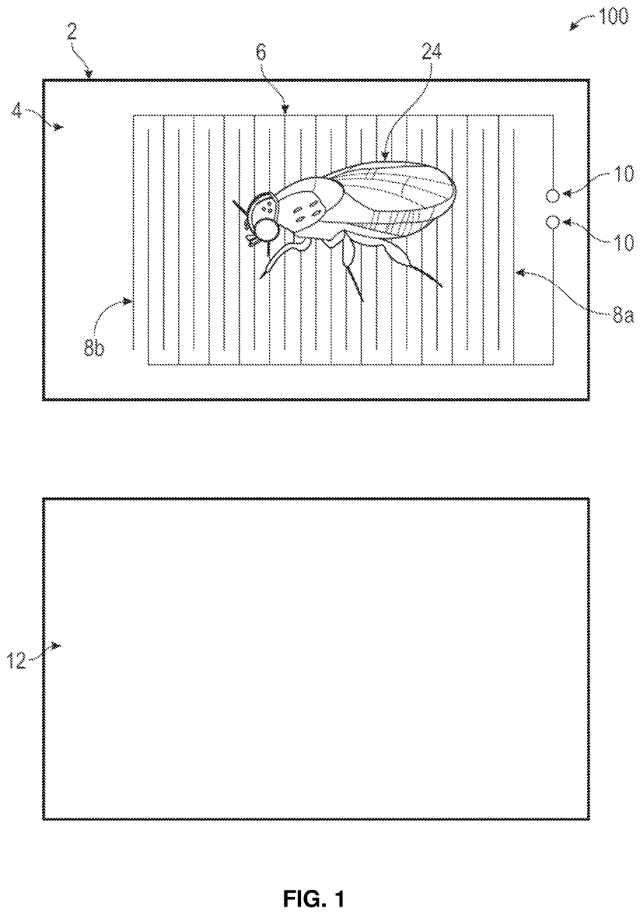

Referring now to FIG. 1, an embodiment of an aversive electroshock device 100 is depicted. The aversive electroshock device 100 may include a board 2, a grid or region 6 having at least two electrical contacts 8a, 8b in which one electrical contact 8a is a positive contact and the other electrical contact 8b is a negative contact, and a connection point 10 in electrical communication with the at least two electrical contacts 8a, 8b. The board 2 has a first surface 4 on a front side and a second surface 12 on a back side. The grid 6 may be disposed on the first surface 4, on the second surface 12, or on both the first surface 4 and the second surface 12. The board 2 may be rectangular, square, triangular, or any other shape. For example purposes, the board 2 seen in FIG. 1 is rectangular.

Referring still to FIG. 1, the board 2 may made from a glass-reinforced epoxy resin. However, other materials are possible and encompassed within the scope of the present disclosure. The grid 6 may be composed of metallic channels, and these metallic channels may be alternating traces. The alternating traces help ensure that an organism 24 makes contact with both a positive electrical contact 8a and a negative electrical contact 8b. The connection point 10 is in electrical communication with the grid 6, and is in electrical communication with the at least two electrical contacts 8a, 8b. The components can be in electrical communication by wire or a conductive track in the board 2. However, any configuration or way to electrically connect the grid 6 and the connection point 10 is possible and encompassed within the scope of the present disclosure. The connection point 10 may be connected to electricity so as to provide an electric shock to an organism disposed on the grid 6 and in contact with the at least two electrical contacts 8a, 8b. The grid 6 does not complete a circuit until an organism 24 is on the grid 6 and touches the at least two electrical contacts 8a, 8b. However, in other embodiments the at least one grid 6 may be composed of a closed circuit without an organism 24 touching it.

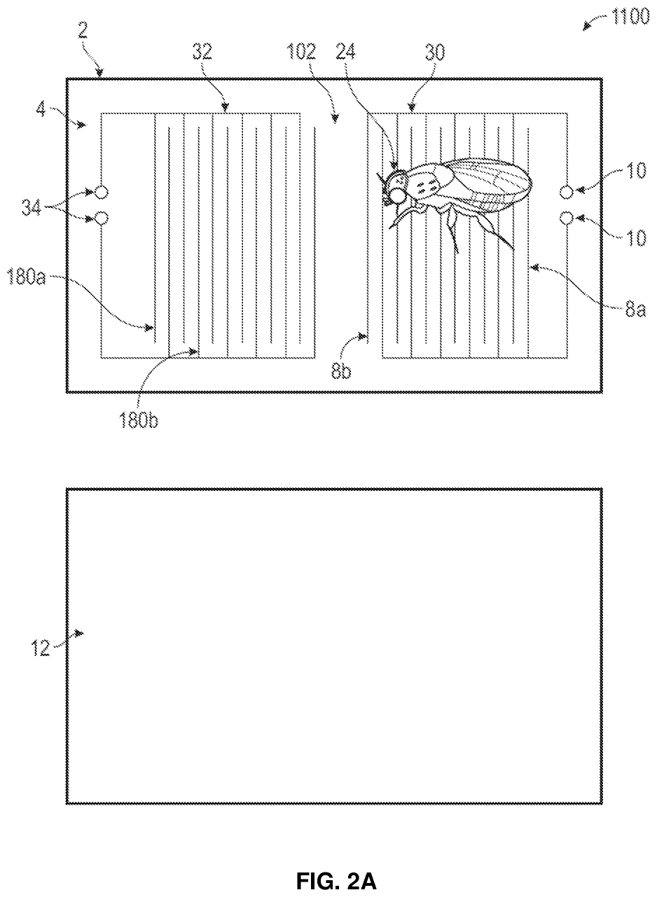

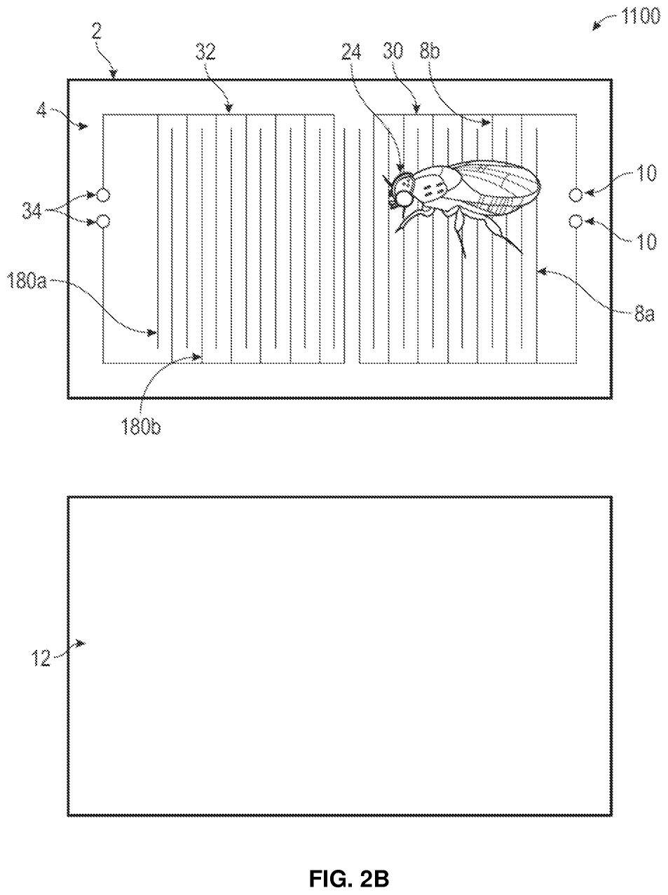

Referring now to FIGS. 2A-2B, another embodiment of an aversive electroshock device 1100 is depicted. The aversive electroshock device 1100 may include a board 2, a first grid 30 having at least two electrical contacts 8a, 8b in which one electrical contact 8a is a positive contact and the other electrical contact 8b is a negative contact, and a second grid 32 having at least two electrical contacts 180a, 180b in which one electrical contact 180a is a positive contact and the other electrical contact 180b is a negative contact. The first grid 30 is in electrical communication with the connection point 10, and the second grid 32 is in electrical communication with the second connection point 34. The way in which the grids 30, 32 and the connection points 10, 34 are electrically connected can be, for example, by wire, or by conductive track in the board 2. However, any structure suitable for connecting the grids 30, 32 to the connection points 10, 34 is possible and encompassed within the scope of the present disclosure.

In the embodiment depicted in FIGS. 2A-2B, only one of the first grid 30 and second grid 32 is typically electrified at a time, so as to provide a non-electrified space otherwise identical in appearance for an organism to move to upon experiencing the aversive stimulus of an electric shock while positioned on the electrified grid 30. Either grid 30, 32 may act as the electrified grid or the non-electrified grid, as both grids 30, 32 include at least a positive electrical contact 8a, 180a and a negative electrical contact 8b, 180b. The board 2 can have a space 102 between the two grids 30, 32, as depicted in FIG. 2A, and the size of the space 102 is customizable based on the desired use. The space 102 can be large or small. Furthermore, in some embodiments, as depicted in FIG. 2B, there is no space 102 between the first grid 30 and the second grid 32, and the first grid 30 is immediately adjacent to the second grid 32. In use, if an animal 24 finds the electrified current from one of the grids 30, 32 painful, then this will be reflected in the fact that the animal 24 spends significantly less time on the particular grid 30, 32.

Referring still to FIGS. 2A-2B, the connection point 10 may be connected to electricity so as to provide an electric current through the grid 30, and thereby an electric shock to an organism 24 disposed on the electrified grid 30 touching both the positive contact 8a and the negative contact 8b so as to complete a circuit. The electrified grid 30 does not complete a circuit until an organism 24 is on the electrified grid 30 and is touching both the positive contact 8a and the negative contact 8b. However, in other embodiments, the second grid 32 can be electrified. The second connection point 34 may be connected to electricity so as to provide an electric current through the grid 32 and therefore an electric shock to an organism 24 disposed on the second grid 32 touching both the positive contact 180a and the negative contact 180b so as to complete a circuit. In other embodiments, both of the first grid 30 and the second grid 32 may be electrified, for example at different voltages.

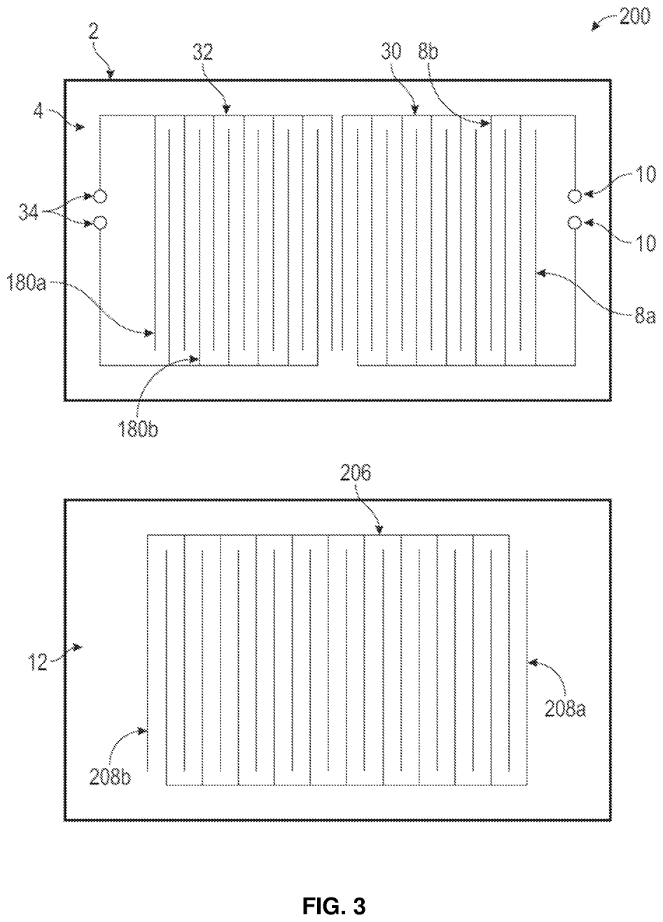

Referring now to FIG. 3, another embodiment of an aversive electroshock device 200 is depicted. In this embodiment, the first surface 4 of the board 2 includes the first grid 30 in electrical communication with the connection point 10, and the second grid 32 in electrical communication with the second connection point 34, and the second surface 12 of the board 2 further includes a third grid 206 that is in electrical communication with the connection point 10. The second grid 206 includes at least two electrical contacts in the form of alternating electrical traces that includes a positive contact 208a and a negative contact 208b.

Referring still to FIG. 3, the connection point 10 may be connected to electricity so as to provide an electric shock to an organism 24 disposed on the first grid 30 or on the third grid 206, while the second connection point 34 may be connected to electricity so as to provide an electric shock to an organism disposed on the second grid 32. In this embodiment, the first grid 30 and the third grid 206 are separate. However, in other embodiments, the first grid 30 and the third grid 206 are one single grid which protrudes through the board 2 from the first surface 4 to the second surface 12. The third grid 206 on the second surface 12 can be used in any of the embodiments described herein.

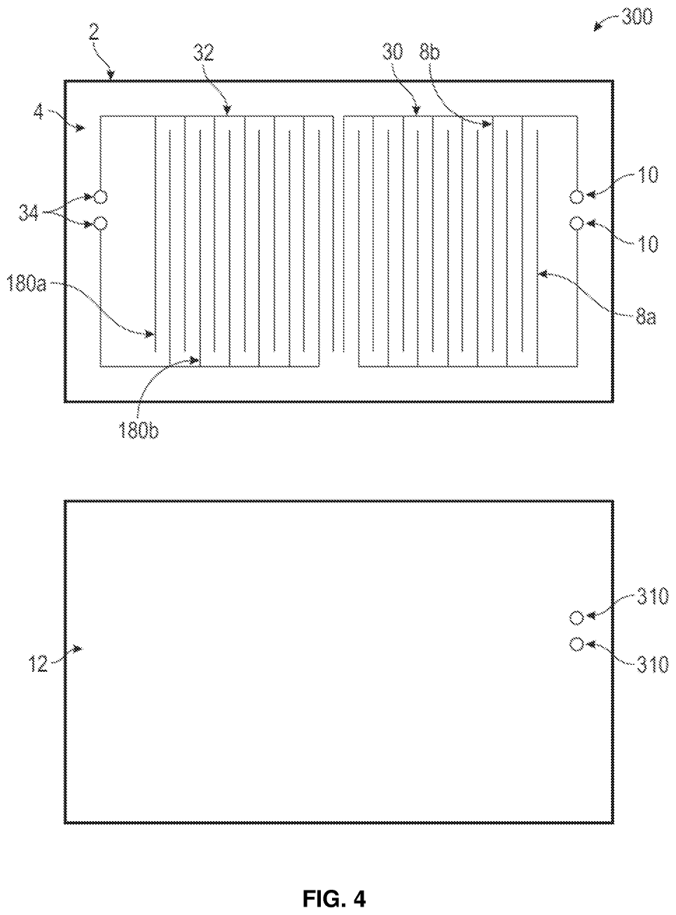

Referring now to FIG. 4, another embodiment of an aversive electroshock device 300 is depicted. In this embodiment, the second surface 12 includes a third connection point 310 that is in electrical communication with the first grid 30. The second connection point 310 may be used not only for applying electricity to the first grid 30 from an alternative side of the board 2, but also for connecting the aversive electroshock device 300 to another device, such as, but not limited to, to another aversive electroshock device 300 in series. The third connection point 310 on the second surface 12 of the board 2 can be used in any of the embodiments described herein.

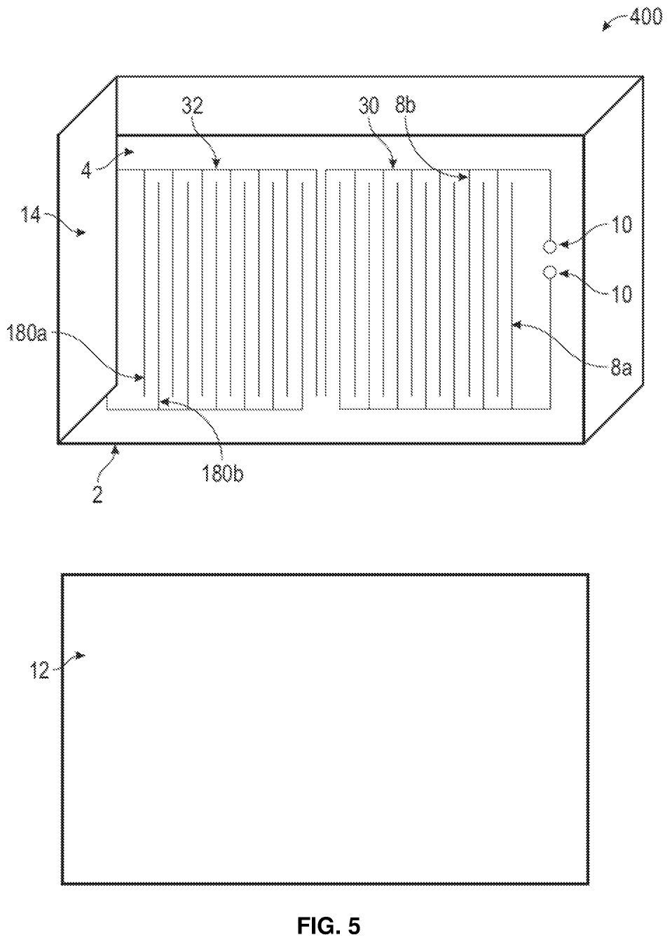

Referring now to FIG. 5, another embodiment of an aversive electroshock device 400 is depicted. In this embodiment, the board 2 further includes at least one wall 14 that is at least partially around a perimeter of the board 2. The wall 14 can be used to keep the organism 24 in the aversive electroshock device 400 as well as for other purposes. The wall 14 may completely encircle the perimeter of the board 2, or may only surround a portion of the perimeter of the board 2, depending on the intended use of the aversive electroshock device 400. The at least one wall 14 can be used in any of the embodiments described herein.

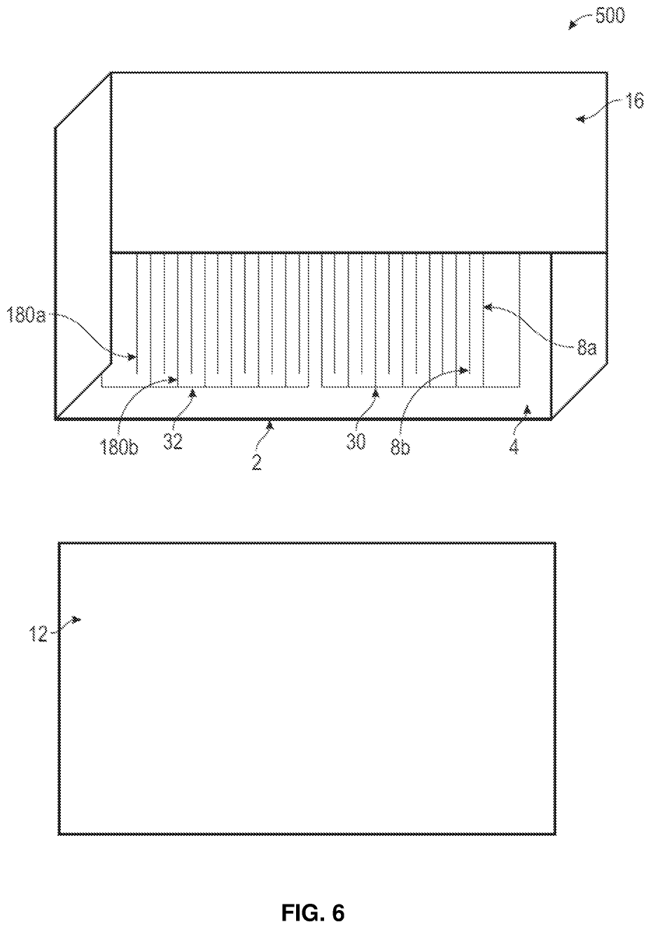

Referring now to FIG. 6, another embodiment of an aversive electroshock device 500 is depicted. In this embodiment, the aversive electroshock device 500 includes the wall 14, and further includes a ceiling 16 that at least partially encloses the first surface 4 of the board 2. The combination of the wall 14 and the ceiling 16 may be particularly useful at ensuring that an organism 24 does not leave prematurely. The ceiling 16 can be used in any of the embodiments described herein.

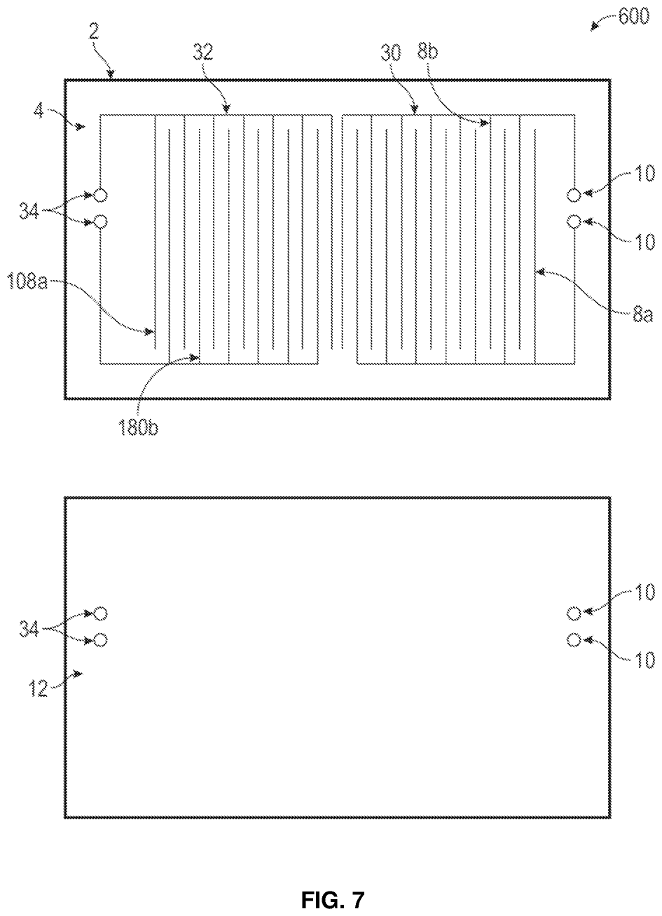

Referring now to FIG. 7, another embodiment of an aversive electroshock device 600 is depicted. In this embodiment, each of the connection point 10 and the second connection point 34 protrudes through the board 2 from the first surface 4 to the second surface 12. Such protrusion allows for the connection point 10 or the second connection point 34 to be connected to an electrical current from a back side of the board 2, but also allows for the aversive electroshock device 600 to be connected to another device, such as but not limited to, another aversive electroshock device 600 in series. Such protrusions also allow for the insertion and attachment of connection pins that can allow connection of a power source. The attachment of the connection pins can be done by any means commonly known in the art such as soldering. Any of the embodiments described herein may include the feature of the connection point 10 and/or the second connection point 34 protruding through the board 2 from the first surface 4 to the second surface 12.

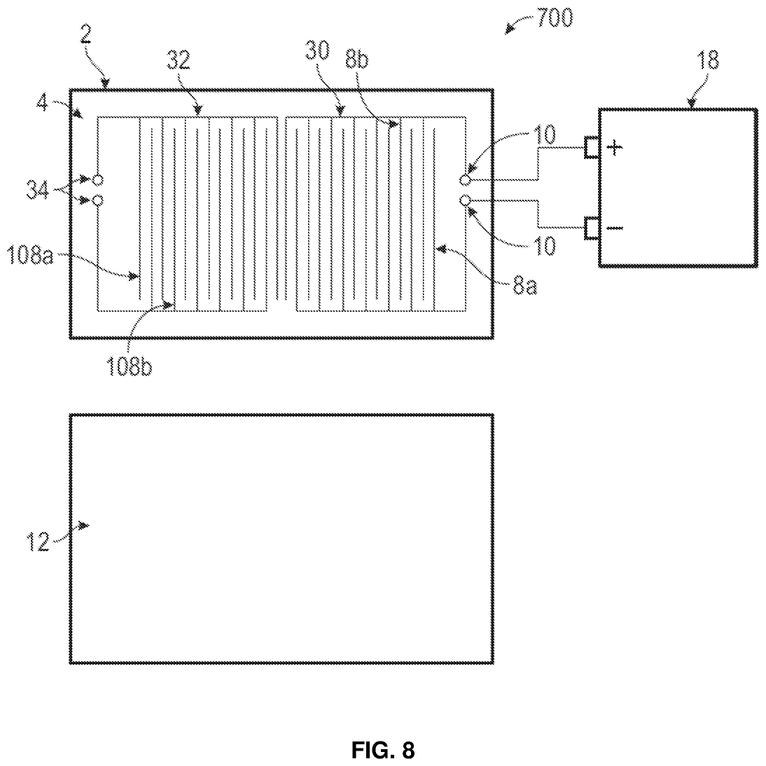

Referring now to FIG. 8, another embodiment of an aversive electroshock device 700 is depicted. In this embodiment, the connection point 10 is connected to electricity by an external power supply 18 to provide an electric shock to an organism 24 disposed on the grid 6. The power supply 18 can be adjusted to control the amount of voltage or current which is supplied to the aversive electroshock device 700, for example to gauge the effectiveness of pharmaceutical compounds or other testable subjects. The first grid 30 does not complete a circuit until an organism 24 is on the first grid 30 and touches at least the positive contact 8a and the negative contact 8b, and the second grid 32 does not complete a circuit until the organism 24 touches at least the positive contact 180a and the negative contact 180b. The power supply 18 can be used in any of the embodiments described herein.

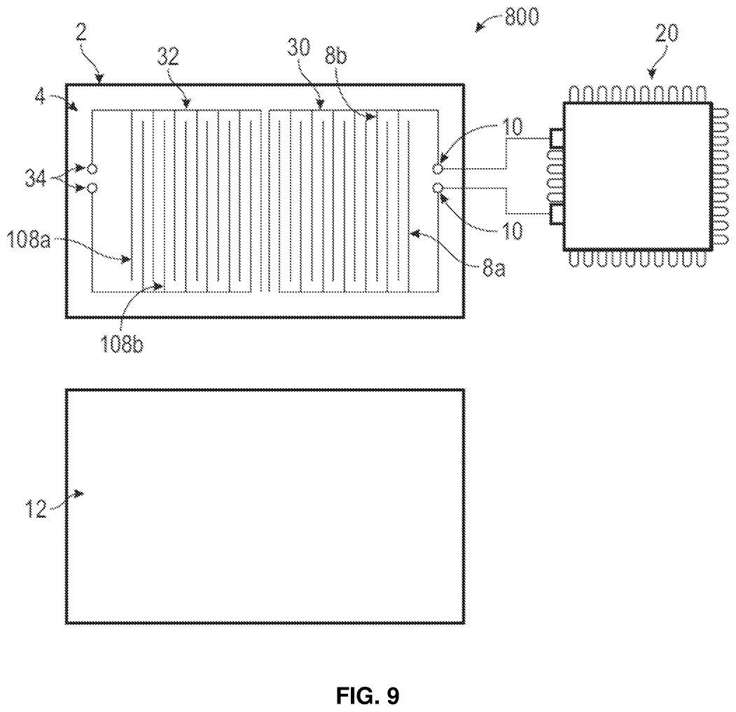

Referring now to FIG. 9, another embodiment of an aversive electroshock device 800 is depicted. In this embodiment, a computer, microcontroller, or microprocessor 20 is in electrical communication with the connection point 10. Electrical communication can be by wire or a conductive track in the board 2, but other methods of connection are possible and encompassed within the scope of the present disclosure. The computer, microcontroller, or microprocessor 20 may be a separate entity or may be integrated into the aversive electroshock device 800 or by any other method of communication with the electroshock device 800. The computer, microcontroller, or microprocessor 20 may be used for any purpose, including, but not limited to, adjusting the amount of voltage or current that is supplied to the first grid 30 and/or the second grid 32. Other example uses of the computer, microcontroller, or microprocessor 20 include adjusting the intensity of the electric current delivered to the connection point 10 or controlling when an electric shock is delivered to an organism 24. The computer, micro controller, or microprocessor 20 may also be used for any other desired purpose. The computer, microcontroller, or microprocessor 20 can be used in any of the embodiments described herein.

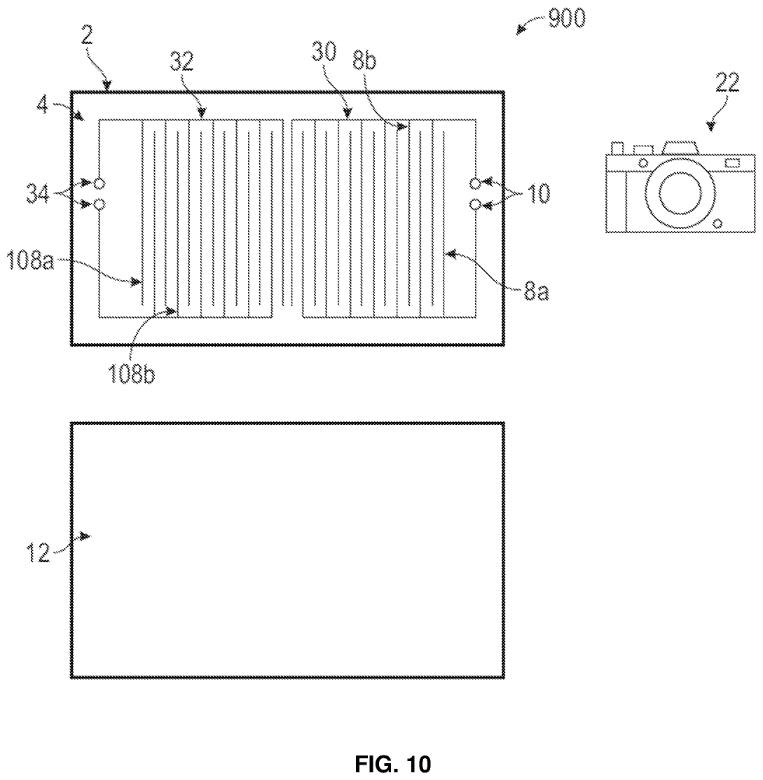

Referring now to FIG. 10, another embodiment of an aversive electroshock device 900 is depicted. In this embodiment, the aversive electroshock device 900 includes a camera 22 configured to observe the board 2. The camera 22 may be a separate component or integrated into the electroshock device 900. The camera 22 can be used to take pictures or video of the organism 24, or the camera 22 can be used for any other desired purpose. Furthermore, the aversive electroshock device 900 is not limited to having only one camera 22; rather, the aversive electroshock device 900 may include a plurality of cameras 22, and may include as many cameras 22 as desired. The camera 22 can be used in any of the embodiments described herein.

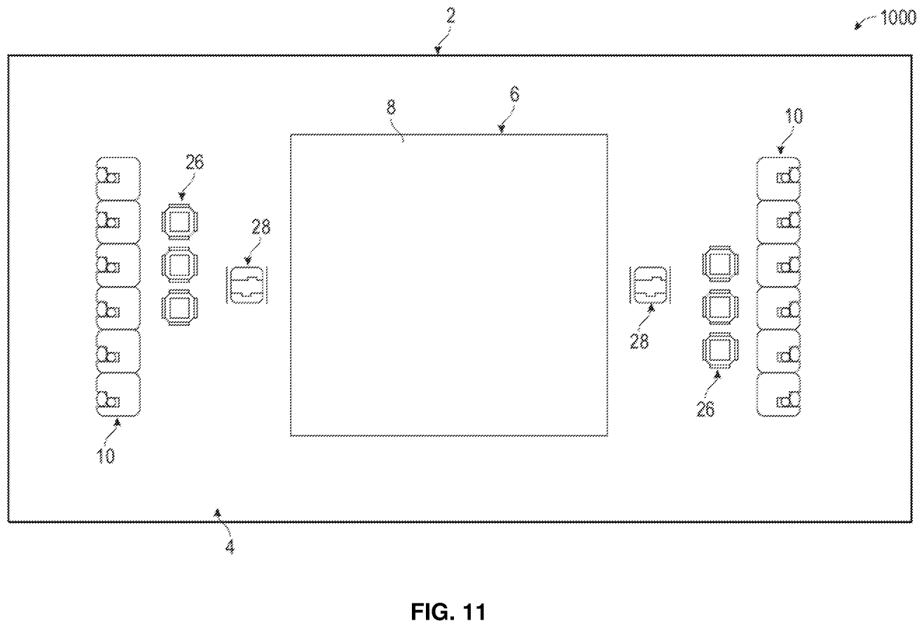

Referring now to FIG. 11, another embodiment of an aversive electroshock device 1000 is depicted. The aversive electroshock device 1000 may include a board 2, a grid 6 having at least two electrical contacts in which one electrical contact is a positive contact and at least one electrical contact is a negative contact, a connection point 10, at least one resistor 26, and a diode 28 such as a light emitting diode (LED). The resistor 26 may be used for controlling the colors of the diode 28. The board 2 in the aversive electroshock device 1000 may also have a combination of grids, as seen in FIG. 2, in which either of the grids can be electrified as desired. Referring back to FIG. 11, the connection point 10 is in electrical communication with the at least two electrical contacts 8, the at least one resistor 26, and the at least one diode 28. The at least one diode 28 can be a light emitting diode, but does not have to be. The board 2 has a first surface 4 and a second surface 12. The at least one resistor 26 and the at least one diode 28 do not have to be on the first surface 4; rather, the at least one resistor 26 and the at least one diode 28 can be on the second surface 12 as well. The components can be in electrical communication by wire or a conductive track in the board 2. However, any configuration or way to connect the grid 6, the connection point 10, the resistor 26, and the diode 28, is possible and encompassed within the scope of the present disclosure. The connection point 10 may be connected to electricity so as to provide an electric shock to an organism 24 disposed on the grid 6 when the organism 24 touches the at least two electrical contacts. The grid 6 does not complete a circuit until an organism 24 is on the grid 6 and touches the at least two electrical contacts 8.

Referring to FIGS. 1-11, any combination of the aversive electroshock devices described can be used. By combination, any one component can be configured to be used on one of the other embodiments to establish any desired purpose. By component, any element including, but not limited to, the board 2, the grid 6, the at least two electrical contacts 8a, 8b, the connection point 10, the at least one wall 14, the ceiling 16, the power supply 18, the computer, microcontroller, or microprocessor 20, the camera 22, the resistor 26, the diode 28, the second grid 32, the third grid 206, the third connection point 310, and second connection point 310 is described.

In accordance with the present disclosure, an aversive electroshock device can be manufactured through many ways. One non-limiting example of a method for making an aversive electroshock device involves using electrically conductive traces that are deposited on a backing material which serves as the floor of an organism's arena. In one non-limiting example, a set of alternating 100 μm copper traces, with 100 μm spacing, can be deposited on FR-4 epoxy resin backing material using standard PCB manufacturing techniques. The walls of the arena can be created by cutting a well from a sheet of acrylic, placed on top of the printed circuit board. The walls of the well can be lined up with the area bearing electric traces, restricting the organism to the electrified space.

An aversive electroshock device as described herein and shown generally at 100, 200, 300, 400, 500, 600, 700, 800, 900, 100, and 1100 can be used, for example, to test pharmaceutical compounds for their effectiveness at inhibiting or reducing a pain threshold of an organism. A method for measuring a pain threshold of an organism may include several steps. For example, with reference to FIGS. 1-11, the first step can be to electrify the first grid 30 at a specific level of voltage. Then, an organism 24 such as a fly may be permitted to walk or land on the first grid 30, and in so doing, the organism 24 contacts both the positive contact 8a and the negative contact 8b, thereby completing a circuit with electricity running through the organism 24, which is experienced by the organism 24 as an electric shock. If the current is high enough to be unpleasant (i.e., painful) for the organism 24, then the organism 24 will tend to avoid the electrified area (namely, the first grid 30). In an alternative embodiment of such a method, the organism 24 walks or lands onto the first grid 30 prior to the first grid 30 being electrified. The aversive electroshock device 100 can also have any number of grids 6 on the board 2. In some non-limiting examples, the aversive electroshock device 100 has eight grids 6. In other non-limiting examples, the aversive electroshock device 100 has four grids 6. In other non-limiting examples, the aversive electroshock device 100 has twelve grids 6. The number of grids 6 is not particularly limited.

In some methods, no electricity is supplied to the second grid 32. In this manner, the second grid 32 can act as a control area, in that the second grid 32 appears identical to the first grid 30 except that it will not provide an electric shock to the organism 24. When the organism 24 moves away from the electrified first grid 30 to the non-electrified second grid 30, this signifies pain experienced by the organism 24 in reaction to the electric shock delivered by the first grid 30. A degree of avoidance can be measured, where the degree of avoidance represents a measure of pain that the organism 24 receives. This process may be carried out as a control, without any test compound having been administered to the organism 24 beforehand. Furthermore, this process may be carried out after a test compound has been administered to the organism 24. The difference in observed or measured pain threshold by the organism 24, following no administration of a test compound and administration of a test compound, can be observed, measured, quantified, and/or characterized so as to determine an effectiveness of the test compound at inhibiting, reducing, or otherwise affecting how the organism 24 experiences pain. Tracking software can be utilized to track the movement of the organism 24.

A method can also include the step of determining a minimum voltage needed to bring about a degree of avoidance as a measure for an intensity threshold which is perceived as painful or noxious.

Though pharmaceutical compounds are described for example purposes, an aversive electroshock device as described herein is not limited to being used for testing pharmaceutical compounds. Rather, the aversive electroshock device can be used to test the effects on pain sensation of any substance or condition that an organism can be exposed to. The aversive electroshock device can also be used to test the effects of any characteristics of an organism (e.g., a specific genetic variant, physiological state, or past experience) on pain sensation. In some embodiments, the organism can be a fly, such as a fruit fly. However, the present disclosure is not limited to flies or even to insects. Rather, any organism can be analyzed with the aversive electroshock device. The aversive electroshock device can be made of a size to accommodate any desired organism.

Applying an electrical shock to an organism can be performed in several different ways. In some embodiments, the electrical shock includes a constant application of a specific voltage. In some embodiments, the electrical shock includes a pulsed application of a specific voltage. In other embodiments, the electrical shock includes a defined progression of different shock intensities. In other embodiments, the electrical shock includes an alternating current in a range of frequencies and intensities. In other embodiments, the method may involve increasing an intensity of the electric shock delivered to the organism incrementally over time. These are not an exhaustive list of possibilities of the types of electric shocks that can be delivered to the organism. Other types of electric shocks are possible and encompassed within the scope of the present disclosure.

The method for measuring a pain threshold of an organism can also include several different types of stimuli other than, or in addition to, an electric shock as described herein. Some non-limiting examples of other types of stimuli include: a light stimulus, a sound stimulus, a chemical stimulus, and an odorant stimulus, and a combination thereof. Any one or more of such other types of stimuli can be applied in conjunction with the electric shock through the electrified grids as described herein. For example, referring to FIGS. 1-10, an electric shock can be used to train an organism 24 to avoid the first grid 30 and then a different stimulus can be applied to the organism 24 while the organism is on the non-electrified second grid 32 in order to assess the degree to which the organism 24 weighs the relative stimuli. In other words, if the second stimulus applied to the organism 24 while on the non-electrified second grid 32 is experienced as more painful by the organism 24 than the electric shock, the organism 24 may choose to return to the electrified first grid 30. In this manner, relative pain perception can be observed.

The aversive electroshock device may also be used in a method for testing spatial memory through sensory cue conditioning. This method may involve, for example, an aversive electroshock device with a board including several grids surrounded by spatial cues. Of the several grids, a first grid is not supplied with electricity, while the remaining grids are supplied with electricity. In one non-limiting example, the aversive electroshock device has eight grids, where one grid is electrified and the remaining seven grids are not electrified. An organism may then be placed on the aversive electroshock device and be observed for a period of time to note any preference for any of the grids, indicating conditioned changes in preference of the grids the organism favors due to receiving an electric shock while in contact with the grids supplied with electricity. This method can also involve observing the amount of time it takes the organism to reach one of the grids that is not supplied with electricity. Also, the method may include cues that are presented to indicate a safe area for the organism. These cues can be any type of cue that the organism can differentiate between normal and different including, but not limited to, LEDs in the wall or around the grids, or panels of color on the wall or around the grids. In one non-limiting example, a green LED is placed around the one grid that is not electrified, and a fly learns to go to the area where the green light is so as to avoid receiving an electric shock. Aside from offering a method to assess learning, the method can also be used for testing spatial memory deficits such as in the context of researching or analyzing a neurodegenerative disease such as, but not limited to, age-related dementia. The organism that is being observed can be any organism, such as, but not limited to, a fly or fruit fly.

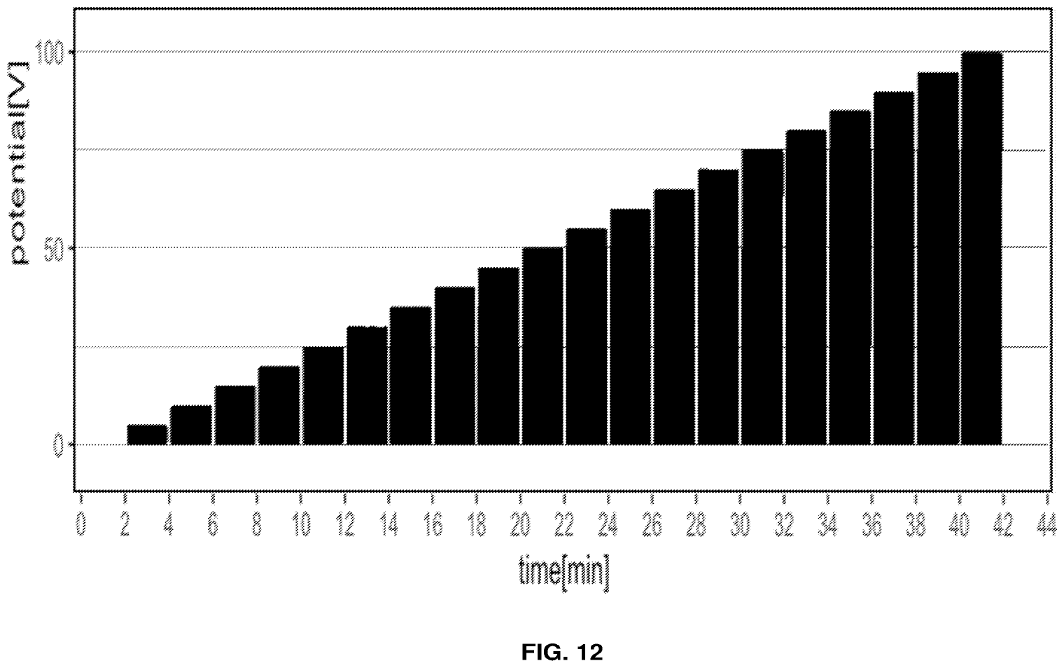

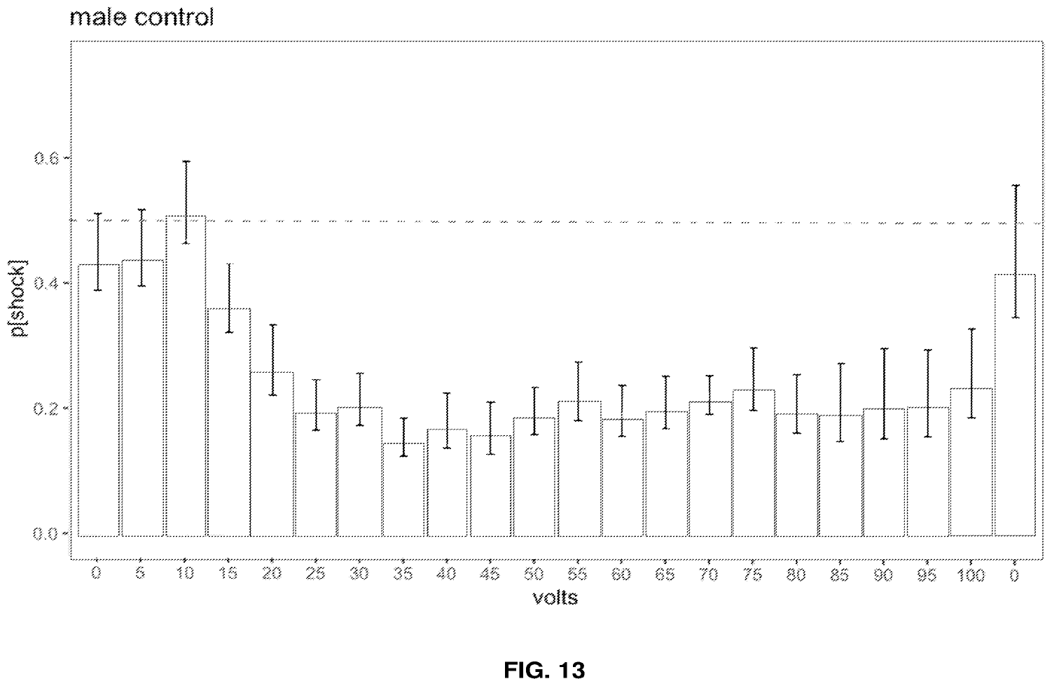

A graph is depicted in FIG. 12 showing the results from a series of increasing voltages applied to one side of the board of an example aversive electroshock device as described herein. The voltages increased from zero volts to one-hundred volts over a period of forty-two minutes with two-minute intervals between incrementing the voltage. This is a non-limiting example of a useful scheme for increasing voltages in order to determine the point at which an organism perceives pain from the electric shock. A graph is depicted in FIG. 13 showing the results of using the voltages provided in FIG. 12 on the avoidance behavior observed of 30 flies tested individually. It was found that flies significantly avoid the side of the board that was being electrified at fifteen volts or higher.

Certain embodiments of the devices and methods disclosed herein are defined in the above examples. It should be understood that these examples, while indicating particular embodiments of the invention, are given by way of illustration only. From the above discussion and these examples, one skilled in the art can ascertain the essential characteristics of this disclosure, and without departing from the spirit and scope thereof, can make various changes and modifications to adapt the devices and methods described herein to various usages and conditions. Various changes may be made and equivalents may be substituted for elements thereof without departing from the essential scope of the disclosure. In addition, many modifications may be made to adapt a particular situation or material to the teachings of the disclosure without departing from the essential scope thereof.

1. An aversive electroshock device comprising:
a board with a first surface and a second surface, the first surface comprising a first grid having a first positive electrical contact and a first negative electrical contact, and a second grid having a second positive electrical contact and a second negative electrical contact;
a first connection point on the first surface in electrical communication with the first positive contact and the first negative contact; and
a second connection point on the first surface in electrical communication with the second positive contact and the second negative contact.

2-5. (canceled)

6. The device of claim 1, further comprising a camera configured to observe the board.

7. The device of claim 1, wherein the first connection point or the second connection point protrudes through the board.

8. The device of claim 1, wherein the first grid and the second grid each comprises conductive channels, wherein the conductive channels comprise alternating traces.

9. (canceled)

10. The device of claim 1, wherein the board comprises a glass-reinforced epoxy resin.

11-12. (canceled)

13. A method for applying an electric shock to an organism, the method comprising:
electrifying the first grid of the aversive electroshock device of claim 1 at a known intensity while not electrifying the second grid;
allowing an organism onto the first grid, wherein the organism contacts the first positive contact and the first negative contact to complete a circuit and receive an electric shock; and
observing a degree to which the organism avoids the first grid.

14. (canceled)

15. The method of claim 13, wherein the degree is a control degree of avoidance, and the method further comprises:
administering a test pharmaceutical compound to the organism after observing the control degree of avoidance; and
observing a second degree to which the organism avoids the first grid, wherein a difference between the control degree of avoidance and the second degree indicates an effect by the test pharmaceutical compound on how the organism perceives pain.

16. The method of claim 13, wherein the organism is a fly.

17. (canceled)

18. The method of claim 13, wherein the electric shock comprises a constant application of a specific voltage, a pulsed application of a specific voltage, a defined progression of different shock intensities, or an alternating current in one of a range of frequencies and intensities.

19-21. (canceled)

22. The method of claim 13, further comprising tracking movement of the organism with a tracking software.

23. The method of claim 13, further comprising increasing an intensity of the electric shock delivered to the organism incrementally over time.

24. (canceled)

25. The method of claim 13, further comprising determining a minimum voltage needed to bring about a degree of avoidance as a measure for an intensity threshold which is perceived as painful or noxious, the degree representing a measure of pain that the organism receives.

26. (canceled)

27. The method of claim 13, further comprising administering a test compound to the organism prior to allowing the organism onto the first grid.

28. A method for applying an electric shock to an organism, the method comprising:
allowing an organism onto the first grid of the aversive electroshock device of claim 1;
electrifying the first grid at a known intensity while not electrifying the second grid, wherein the electrifying causes an electric current to flow through the organism upon the organism contacting the first positive contact and the first negative contact; and
observing a degree to which the organism avoids the first grid.

29. (canceled)

30. The method of claim 28, wherein the degree is a control degree of avoidance, and the method further comprises:
administering a test pharmaceutical compound to the organism after observing the control degree of avoidance; and
observing a second degree to which the organism avoids the first grid, wherein a difference between the control degree of avoidance and the second degree indicates an effect by the test pharmaceutical compound on how the organism perceives pain.

31-32. (canceled)

33. The method of claim 28, further comprising increasing an intensity of the electric shock delivered to the organism incrementally over time.

34-36. (canceled)

37. The method of claim 28, further comprising administering a test compound to the organism prior to allowing the organism onto the first grid.

38-39. (canceled)

40. A method of measuring the pain threshold of an organism, the method comprising:
placing an organism into an area comprising a first region and a second region, wherein the first region is configured to deliver an aversive stimulus to the organism while the second region is safe from the aversive stimulus;
incrementally increasing an intensity of the aversive stimulus over time; and
measuring a strength of an avoidance reaction by the organism as a function of the intensity, wherein a minimum intensity needed to bring about avoidance of the first region represents a measure for an intensity threshold at which the aversive stimulus is perceived as painful or noxious, and a degree of avoidance at a higher intensity represents a measure of how painful the aversive stimulus is perceived by the organism.

41. The method of claim 40, wherein the first region is electrified, and a state of electrification of the first region is coordinated with a state of a signal.

42. The method of claim 41, wherein a signaling cue acts as a warning signal that precedes application of an electric shock to warn the organism of an imminent electric shock or to reflect a current state of electrical activation.

43. The method of claim 41, wherein a paired cue is used to signal the potential for activating electrical shock when additional conditions are met.

44-49. (canceled)

50. A method of testing spatial memory through sensory cue conditioning, the method comprising:
placing an organism into an area comprising a plurality of grids, wherein a first grid of the plurality of grids is not supplied electricity while a remainder of the plurality of grids is supplied with electricity so as to deliver an electric shock to the organism when the organism is positioned on any of the remainder of the plurality of grids;
observing the organism over a period of time; and
identifying changes in a preference of the organism for the first grid.

51. The method of claim 50, further comprising presenting cues that indicate a safe area to the organism.

52-56. (canceled)

57. The method of claim 50, comprising measuring a relative amount of time spent by the organism on the first grid compared to any of the remainder of the plurality of grids.
